(19) United States
(12) Patent Application Publication
(10) Pub. No.: US 2009/0277575 A1
(43) Pub. Date: Nov. 12, 2009

(54) Yarn having laminated structure

(76) Inventors: Michiko Omori, Ashiya-shi (JP); Sataro Shimazaki, Osaka (JP)

Correspondence Address: JORDAN AND HAMBURG LLP, 122 EAST 42ND STREET, SUITE 4000, NEW YORK, NY, 10168, US

(21) Appl. No.: 12/460,652

(22) Filed: Jul. 21, 2009

Related U.S. Application Data
(62) Division of application No. 10/311,601, filed on Dec. 18, 2002, now abandoned.

(30) Foreign Application Priority Data
Jun. 19, 2000 (JP) 2000-183342

(51) Int. Cl. B32B 37/00

(52) U.S. Cl. 156/269

(57) ABSTRACT

A laminated yarn, which is characterized in that it is prepared by a method comprising evaporating an antibacterial metal onto a synthetic resin film to form a vapor deposition membrane, adhering the resultant synthetic resin films so as for the vapor deposition membrane to be positioned inside, and cutting the resultant laminated film having a sandwiched structure in a long narrow form along its longitudinal direction. The yarn is free from the lowering of antibacterial activity by repeated washing, is excellent in the prevention of rise in its temperature, the insulation of heat and an electromagnetic wave, and antistatic properties, and has excellent appearance.

This is a Divisional application of U.S. Ser. No. 10/311,601 filed Dec. 18, 2002.

### FIELD OF THE INVENTION

This present invention relates to a laminated yarn, and in particular, to have various excellent characteristics, such as aesthetic appreciation property, antibacterial property, washing resistance, prevention of temperature rising, insulation of heat, antistatic property, flexibility, insulation of electromagnetic wave.

### BACKGROUND ART

In recent years, articles equipped with antibacterial property is required with development of hygienic way of thinking, and it goes without saying that not only in gauze and bandage for medical treatments, but in clothes or dishcloth materials equipped with antibacterial property is increasingly required. In these gauze and the like equipped with antibacterial property are used as a material.

As such antibacterial yarns, fine metallic yarns in which silver and copper are drawn long and slender, metal plated yarns with silver and steel plated on a surface of yarns, such as synthetic fibers, and yarns including the antibacterial agent that the antibacterial agent is mixed therein or is applied thereon and the like are conventionally used.

Moreover, from a viewpoint of reduction of displeasure to wearer by static electricity, and of prevention of electrostatic failure by static electricity over electronic products, various antistatic textiles are used. As such antistatic textiles, textiles including carbon fiber, and textiles in which processing by chemicals is given in silk-reeling process or dyeing process are conventionally used.

Moreover, in the medical field, a gauze is rolled on a suture part of a living body to close the affected part in the case of an operation, and after the gauze concerned is removed in a predetermined period, the amount of bleeding from a suture part is measured for examining procedure after the operation is conducted. As such gauze, materials blocking X rays including vinyl chloride yarn or a fine metallic yarn is used in order to easily find out the applied location.

In addition, in order to reduce displeasure caused by atmospheric temperature variation, clothes in which heat of vaporization at the time of sweat evaporation is utilized to accelerate cooling effect, clothes equipped with exothermic mechanism using evaporation of water content, such as sweat, and clothes in which electric heating wire is woven are utilized.

However, when it was required to give various characteristics, such as antibacterial property, to textiles by using conventional fine metallic yarns, carbon fiber and the like in textiles, there have been the following problems.

Firstly in a fine metallic yarn or metal plated yarn, when these were used for textiles there was a problem that deterioration of appearance of the textiles was induced or an antibacterial property was fallen since the surface oxidizes with aging, a bleaching agent or the like and the surface was blackened. In addition, since the metal portions of these fine metallic yarns or metal plated yarns were easily heated by infrared radiation and the like, when infrared warming treatment was done with the textiles including them as a material worn, for example, there was also a problem that a low-temperature burn was induced.

Next, in yarns including the antibacterial agent, there was a problem that antibacterial property was decreased and lost by repeated washing in a short period of time since the antibacterial agent was eluted by washing.

Moreover, since carbon fiber that is one of antistatic yarn is a black yarn, it has a problem that articles in which the yarn might be used were limited in view of an appearance of the articles, and there was a problem of losing antistatic property by repeated washing when treatment by chemicals was conducted in silk-reeling process or dyeing process.

Moreover, although the gauze made of a vinyl chloride yarn or a fine metallic yarn contributed to X ray imaging, it had a problem in the function of gauze original as textiles, such as toxicity or the poor touch and the poor flexibility. Moreover, in clothes accelerating cooling effect with heat of vaporization at the time of sweat evaporation, although a fixed thermoregulation function and a fixed insulation of heat were equipped, they only had either of the function of cooling or heating, and therefore the usage was also limited.

In addition, even if a plurality of these yarns were combined, it was difficult to manufacture textile products equipped with a plurality of characteristics, such as antibacterial property, antistatic property, prevention of temperature rising, flexibility, an insulation of electromagnetic wave, and good appearance.

Then, an object of the present invention is to provide a laminated yarn equipped with antibacterial activity that is not decreased even after repeated washing, prevention of temperature rising, insulation of heat, antistatic property, flexibility, outstanding insulation of electromagnetic wave and the like, and also equipped with outstanding good appearance.

### DISCLOSURE OF THE INVENTION

Namely, a laminated yarn according to the present invention is characterized in that antibacterial metal is vapor-deposited onto a synthetic resin film to form a vapor deposition membrane, the formed synthetic resin films are adhered so that a vapor deposition membrane may be placed inside, and resultant laminated film obtained by being adhered into a sandwiched structure is cut in lengthwise direction to give a long and narrow form.

Moreover, a coat layer may be prepared on a surface of synthetic resin film opposite to a surface on which vapor deposition membrane is formed, and a coat layer may be prepared between a synthetic resin film and a vapor deposition membrane or on a vapor deposition membrane.

### BRIEF DESCRIPTION OF THE DRAWINGS

FIG. 1 is a view typically showing a structure of a laminated yarn;

FIG. 2 is a graph showing a result of an examination of prevention of temperature rising;

FIG. 3, FIG. 4, and FIG. 5 are views typically showing structures of other laminated yarns.

### BEST MODE FOR CARRYING OUT THE INVENTION

Hereinafter, embodiments of the present invention will be described based on drawings.

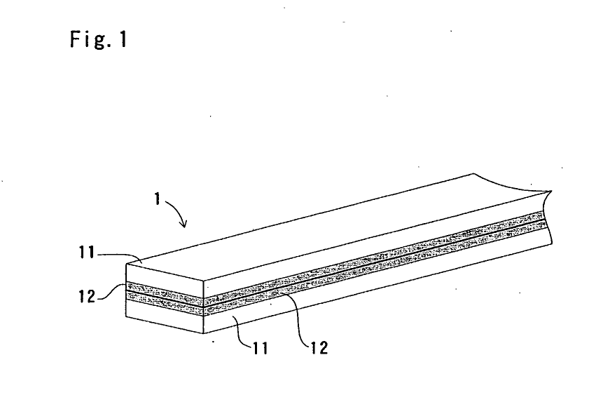

FIG. 1 is a view showing typically a structure of a laminated yarn 1 according to the present invention. As is shown in this figure, a laminated yarn 1 is a yarn having a sandwiched structure in which a vapor deposition membrane 12 made of an antibacterial metal is sandwiched by synthetic resin films 11, and is formed by a procedure as shown below.

First, antibacterial metal is vapor-deposited by a vacuum deposition method or an ion vacuum deposition and the like to form a vapor deposition membrane 12 on a synthetic resin film 11. Next, the synthetic resin films 11 with vapor deposition membrane 12 formed thereon are adhered with adhesive so that the vapor deposition membranes may be placed inside to manufacture a laminated film with a sandwiched structure in which antibacterial metal is sandwiched between the synthetic resin films. Finally, the laminated film is cut in lengthwise direction and a laminated yarn 1 is obtained.

Here, synthetic resin film here is a film made of polyester, nylon, polyethylene, polypropylene and the like, and a thickness is about 4 to 50 microns, and preferably about 4 to 12 microns.

Moreover, metals that is used here as layer are metals having antibacterial property in which ion exchange is enabled, such as silver, copper, and zinc, especially, silver is the optimal in view of anti-rust property and high antibacterial ability. A thickness of the vapor deposition membrane 12 is about 20 to 100 nm, and preferably about 50 to 100 nm in view of guarantee of function and product cost, and when thickness is set as 700 nm or more, electromagnetic wave in a broad range from infrared radiation to X ray may be blocked without a coat layer prepared.

Furthermore, as the above-described adhesives, although polyurethane derived adhesives, polyester derived adhesives, and acrylic adhesives may be mentioned, taking safety of textiles in which low formalin property is required into consideration, adhesives of polyurethane derived or polyester derived is preferable.

Thus, the laminated yarn 1 is a yarn that has a sandwiched structure in which a vapor deposition membrane 12 made of antibacterial metal is sandwiched between synthetic resin films 11, and is a yarn equipped with color of the antibacterial metal.

In addition, a width in the case where a laminated film is cut in lengthwise direction is about 0.1 to 1.0 mm. Especially, when a balance of various characteristics, such as aesthetic appreciation property, anti-static property, and insulation of heat are taken into consideration, the width is desirably about 0.15 to 0.226 mm.

Thus, since side edges of the vapor deposition membrane 12 are exposed outside and are oxidized or chlorinated, but the oxidized portion concerned may be removed because of mutual abrasion between adjoining fibers, and if not removed the portion concerned may not be observed with naked eyes. Moreover, since it is protected by the synthetic resin films 11, any portions other than the side edges of the vapor deposition membrane 12 are not oxidized or chlorinated. Therefore, even if it receives repeated washing, or is bleached, antibacterial activity will not be deteriorated, or the vapor deposition membrane 12 will not be blackened to deteriorate appearance of textiles.

Moreover even if heat is added from outside, since most of the metal vapor deposition membranes 12 are covered with synthetic resin films, temperature of the laminated yarn 1 will not rise rapidly to induce low-temperature burn, and even if static electricity is induced in clothes with the laminated yarn 1 woven therein, since static electricity may be removed outside through the vapor deposition membrane 12 not to charge static electricity.

Furthermore, since a broad range of electromagnetic wave from infrared radiation to X-rays is blocked with a work of metal that forms the vapor deposition membrane, high insulation of electromagnetic wave and high insulation of heat are equipped, and since it is based on a synthetic resin film, it has high flexibility.

Subsequently, a laminated yarn according to the present invention will be manufactured and various examinations will be conducted to describe the present invention still in detail.

### “Experiment 1”

### (1) Manufacture of a Laminated Yarn

Solid silver was vapor-deposited by an ion vacuum deposition method, and a vapor deposition membrane with a thickness of 50 nm was formed on a polyester film (manufactured by Toyobo Co., Ltd.) with a thickness of 12 microns. Next, the above-described polyester films with vapor deposition membrane were adhered together so that the vapor deposition membranes are placed inside with polyester derived adhesive to manufacture a laminated film having a sandwiched structure. Finally, the above-described laminated film was cut so that it might have width of 226 microns in lengthwise to obtain a laminated yarn, and the laminated yarn was presented to following various examinations.

### (2) Antibacterial Examination

A toweling in which the laminated yarn was woven in as ground yarn so that 6 mm of space might be given was used for antibacterial examination conducted by a shake flask method. In addition, Klebsiella pneumoniae was used as a sample bacillus, and a cloth (made of nylon) which was not processed was used as experimental control. Results are shown in Table 1.

TABLE 1

| | Number of | | |
|---|---|---|---|
| | bacilli | Number of | |
| | immediately | residual bacilli | Rate in |
| | after | after 18 hours | reduction of |
| Sample | inoculation | 35° C. | bacilli (%) |
| Toweling | 1.1 × 10⁴ | 3.0 × 10³ | 72.7 |
| Unprocessed cloth | 1.1 × 10⁴ | 1.2 × 10⁴ | −9.1 |
| (made of nylon) | | | |

Next, a tiptoe portion of socks in which the laminated yarn was knit at intervals of about 1 mm was used, and antibacterial examination was conducted by a shake flask method. In addition, Klebsiella pneumoniae was used as a sample bacillus, and a cloth (made of nylon) which was not processed was used as experimental control. Results are shown in Table 2.

TABLE 2

| | Number of | | |
|---|---|---|---|
| | bacilli | Number of | |
| | immediately | residual bacilli | Rate in |
| | after | after 18 hours | reduction of |
| Sample | inoculation | 35° C. | bacilli (%) |
| Tiptoe portion of | 1.7 × 10⁴ | 7.4 × 10³ | 56.5 |
| socks | | | |
| Unprocessed cloth | 1.7 × 10⁴ | 1.6 × 10⁴ | 5.9 |
| (made of nylon) | | | |

Furthermore, a panty hose in which the laminated yarn was knit at intervals of 2 mm was used, and antibacterial examination was conducted by a number of bacilli measuring method by SEK. In addition, Trichophyton was used as a sample bacillus, and a cloth (made of nylon) that was not processed was used as experimental control. Results are shown in Table 3.

TABLE 3

| | Number of | | |
|---|---|---|---|
| | bacilli | Number of | |
| | immediately | residual bacilli | Rate in |
| | after | after 18 hours | reduction of |
| Sample | inoculation | 37° C. | bacilli (%) |
| Panty hose | 8.0 × 10⁴ | 10 or less | 99.9 or more |
| | | (growth of | |
| | | bacillus not | |
| | | observed) | |
| Unprocessed cloth | 8.0 × 10⁴ | 6.3 × 10⁴ | 21.3 |
| (made of nylon) | | | |

As is clear from Tables 1, 2, and 3, when a same number of sample bacillus was inoculated and then a number of residual bacilli after predetermined period was compared, a sufficient difference was observed between the sample and the experimental control, and it was recognized that the laminated yarn had a sufficient antibacterial effect. Moreover, it was recognized that an antimicrobial spectrum of the above-described laminated yarn showed a broad spectrum from Klebsiella pneumoniae that is bacteria (procaryote) to Trichophyton that is fungus (eukaryote).

### (3) Washing Resistance Examination

A toweling in which the laminated yarn was woven in as ground yarn so that 4 mm of space might be given was washed predetermined number of times, ant then antibacterial examination was performed by a shake flask method, and a change of antibacterial activity by washing was examined. In addition, Klebsiella pneumoniae was used as a sample bacillus. Results are shown in Table 4.

TABLE 4

| | Number of | | |
|---|---|---|---|
| | bacilli | Number of | |
| | immediately | residual bacilli | Rate in |
| Number of times | after | after 18 hours | reduction of |
| of washing | inoculation | 35° C. | bacilli (%) |
| With no washing | 1.5 × 10⁴ | 4.2 × 10³ | 72.0 |
| After 50 times of | 1.5 × 10⁴ | 4.0 × 10² | 97.3 |
| washing | | | |
| After 100 times | 1.5 × 10⁴ | 1.0 × 10² | 99.3 |
| of washing | | | |
| After 200 times | 1.5 × 10⁴ | 5.2 × 10 | 99.7 |
| of washing | | | |

Next after a food wrapping cloth in which the laminated yarn was woven in as ground yarn so that 5 mm of space might be given was washed predetermined number of times, antibacterial examination was performed by a shake flask method, and change of antibacterial activity by washing was examined. In addition, Escherichia coli was used as a sample bacillus. Results are shown in Table 5.

TABLE 5

| | Number of | | |
|---|---|---|---|
| | bacilli | Number of | |
| | immediately | residual bacilli | Rate in |
| Number of times | after | after 18 hours | reduction of |
| of washing | inoculation | 35° C. | bacilli (%) |
| With no washing | 1.6 × 10⁴ | 2.8 × 10³ | 82.5 |
| After 10 times of | 1.6 × 10⁴ | 1.6 × 10³ | 90.0 |
| washing | | | |
| After 20 times of | 1.6 × 10⁴ | 2.0 × 10² | 98.8 |
| washing | | | |
| After 30 times of | 1.6 × 10⁴ | 4.0 × 10² | 97.5 |
| washing | | | |

Furthermore, after a food wrapping cloth in which the laminated yarn was woven in as ground yarn so that 5 mm of space might be given was washed predetermined number of times, antibacterial examination was performed by a SEK standardized examining method, and change of antibacterial activity by washing was examined.

In addition, Escherichia coli O-157 was used as a sample bacillus, and a cotton gauze was used as experimental control. Results are shown in Table 6.

TABLE 6

| | Number of | | |
|---|---|---|---|
| | bacilli | Number of | |
| | immediately | residual bacilli | Rate in |
| Number of times | after | after 18 hours | reduction of |
| of washing | inoculation | 37° C. | bacilli (%) |
| Cotton gauze | 1.6 × 10⁴ | 5.2 × 10⁷ | −3.2 × 10⁵ |
| After 10 times of | 1.6 × 10⁴ | 5.0 × 10² | 96.9 |
| washing | | | |
| After 20 times of | 1.6 × 10⁴ | <1.0 × 10² | 99.4 |
| washing | | | |
| After 30 times of | 1.6 × 10⁴ | 1.0 × 10³ | 94.0 |
| washing | | | |

As is clear from Tables 4, 5, and 6, even after repeated washing, antibacterial activity of the laminated yarn did not decline, and moreover it turned out that impurity was decreased as the washing was repeated thereby improve antibacterial activity.

### (4) Chlorine Bleaching Agent Resistance Examination

About 10 g of laminated yarn was bundled and a change of color was observed after predetermined number of times of bleaching was carried out. In addition, as bleaching liquor, a liquid in which 12 ml of kitchen bleaching agent was added to 300 ml of distilled water was used, and in order to evaluate difference by temperature, examination temperature was varied to conduct experiment. Results are shown in table 7.

TABLE 7

| | number of repetitions | | |
|---|---|---|---|
| Bleaching condition | 1 | 2 | 7 |
| Bleaching test | Change not | Change not | Change not |
| [symbol] 0° C. × 30 minutes) | observed | observed | observed |
| Bleaching test | Change not | Change not | Change not |
| [symbol] 0° C. × 30 minutes) | observed | observed | observed |

[symbol]

indicates data missing or illegible when filed

As is clear from Table 7, even if the bundled laminated yarns were bleached, in particular, even if bleached under severe conditions of 50° C. and 30 minutes, it was confirmed that the laminated yarns did not blackened.

### (5) Prevention of Temperature Rising Examination

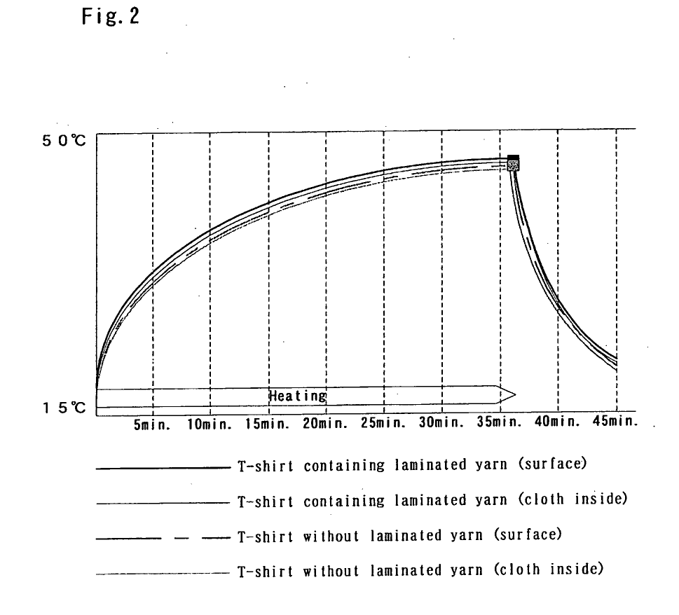

A piece of T-shirt was sawn from a plain knit fabric in which the laminated yarn was knit at intervals of 5 mm, and the T-shirt concerned was heated with an infrared lamp from a position about 20 cm above to evaluate a surface and inside portion of the fabric for temperature variation. Results are shown in a graph of FIG. 2. In addition, a T-shirt that did not include the laminated yarn was used as experimental control.

As is clear from FIG. 2, even if the laminated yarn was woven in, prevention of temperature rising did not fall, and it turned out that a same level of temperature rise was shown as in the experimental control.

### (6) Insulation of Heat Examination

A core yarn with cotton yarn count of No. 30 single in which the laminated yarn as core was covered with cotton staple fiber was manufactured, and a coat cloth was manufactured in which 20 (A), 12 (B), and 7 (C) per 1 inch of the cored yarn, respectively, was included as warp yarn or weft yarn. And coat cloths (A), (B), and (C), and a coat cloth that did not include the laminated yarn (blank) were irradiated by a light from a front side of the cloths to measure a difference of temperature between front and back side of the cloths. A change by passage of time of difference of temperature in front and back side of the cloth are shown in Table 8, and measured temperature of each of the cloths after 5-minute irradiation are shown in Table 9.

TABLE 8

Irradiation Period (min)

| Sample name | 0 | 1 | 2 | 3 | 4 | 5 |
|---|---|---|---|---|---|---|
| (A) | 0.2 | 3.2 | 5.9 | 7.9 | 9.6 | 11.1 |
| (B) | 0.2 | 3.1 | 5.9 | 7.7 | 9.3 | 10.5 |
| (c) | 0.2 | 2.8 | 5.5 | 7.3 | 9.1 | 9.9 |
| Blank | 0.3 | 2.8 | 5.4 | 7.2 | 8.3 | 9.1 |

(° C.)

TABLE 9

| | Irradiation period (min) |
|---|---|
| Sample name | 5 |

| | | |
|---|---|---|
| (A) | Front side | 44.0 |
| | Back side | 32.8 |
| (B) | Front side | 43.6 |
| | Back side | 35.0 |
| (C) | Front side | 43.3 |
| | Back side | 35.2 |
| | Front side | 43.7 |
| Blank | Back side | 35.3 |

(° C.)

In Tables 8 and 9, when a difference of temperatures on front side of the cloth and on backside after 5 minutes of light irradiation was compared, it turned out that a difference of temperature in (A) including 20 of core yarns per 1 inch was larger about 2 to 3° C. compared with the blank. Therefore it turned out that insulation of heat was improved when core yarn including the laminated yarn was woven in.

### (7) Antistatic Property Examination

A T-shirt manufactured in (5) was used and antistatic functional examination was conducted according a method in JIS 1094-5 publication. Measurement conditions are temperature of 20° C., and 20% of humidity. Results are shown in Table 10. In addition, a T-shirt that did not include the laminated yarn was used as experimental control.

TABLE 10

| | Half value | | Charged amount |
|---|---|---|---|
| | period | Triboelectrification | measurement of |
| | measurement | voltage | triboelectrifications |
| Sample | (SEC) | measurement (V) | (μC/m²) |
| T-shirt | 46.5 | 50 or less | 0.19 |
| including the | | | |
| laminated yarn | | | |
| T-shirt | 12.0 | 1320 | 1.57 |
| without the | | | |
| laminated yarn | | | |

As is shown in Table 10, charge and voltage of static electricity accumulated in the T-shirt fell, showing that antistatic function was improving by the laminated yarn woven therein.

### “Experiment 2”

### (8) Manufacture of Twisted Yarn

A metal layer with a thickness of 50 nm made of solid silver (99.99% of purity, manufactured by Mitsubishi Materials Corporation) was formed by a vacuum deposition technology on a polyester film (manufactured by Toray Corporation) having a thickness of 9 microns. The synthetic resin films obtained were adhered together with a polyester system adhesive (manufactured by SUMITOMO 3M Limited) so that the vapor deposition membranes might be placed inside, and was cut out by the width of 150 microns to manufacturer a laminated yarn. And two polyester yarns of 30 deniers/5 filament were twisted by right and left opposite direction around the laminated yarn, and a twisted yarn was manufactured.

### (9) Manufacture of a Cloth for Gentleman Suit Lining Cloth

Warp yarns warped so that polyester yarn (manufactured by Toray Corporation) of 50 deniers/10 filaments might be 150 ends per 1 inch, and weft yarns in which 30 ends of polyester yarns (manufactured by Toray Corporation) of 75 deniers/72 filaments, and the twisted yarn manufactured in (8) were combined so that it may be 70 ends per 1 inch in total were woven to obtain a twill cloth. The twill cloth after scoured was dyed in blue by disperse dyes to manufacturer a cloth for gentleman suit lining cloth. In addition, the twisted yarn in the cloth for gentleman suit lining cloth showed a blue metallic color, and space of the twisted yarns was about 10 mm.

### (10) Antistatic Property Examination

An experimental control using a polyester yarn (manufactured by Toray Corporation) of 75 deniers/72 filaments instead of the twisted yarn was manufactured by a same method as in (9). The cloth was rubbed for 1 minute with a nylon and acrylic cloth under an environment of temperature of 20° C., and 20% of humidity, and a charged voltage at a moment when friction was stopped was measured, and an electrostatic resistance examination was conducted. Accordingly, a charged voltage in a cloth for gentleman suit lining cloth manufactured in (9) showed 300 volts or less in contrast to the charged voltage of the experimental control exceeding 4000 volts.

### “Experiment 3”

Manufacture of a cloth for gentleman suit lining cloth Except that the twisted yarn manufactured in (8) was 10 ends in an equal pitch in 1 inch, and that a cloth was dyed in black by disperse dyes, a cloth for gentleman suit lining cloth was manufactured in a same method as in (9). In addition, the twisted yarn in the cloth for gentleman suit lining cloth showed a black metallic color, and space of the twisted yarns was about 2.5 mm.

### (12) Insulation of Heat Examination

An experimental control in which a polyester yarn (manufactured by Toray Corporation) of 75 deniers/72 filaments was used instead of the twisted yarn was manufactured by a same method as in (11), and insulation of heat examination was conducted according to following procedures of (a) to (d). Firstly, (a) lights (two National lamps: PRF-500 wWB were used) were installed in one side; (b) the experimental control and the cloth for gentleman suit lining cloth manufactured in (11) were placed combined with a brown clothing fabric forming two sheet doubling in a shape of a screen, respectively, in a place making a right angle in a progress direction of the light distant from the light 30 cm; (c) irradiated for 5 minutes by the light; (d) a difference of temperatures in a light side and an opposite side of the experimental control and the cloth for gentleman suit lining cloth manufactured in (11) was measured.

As a result, a temperature in the light side of the experimental control showed 44.8° C., and a temperature in opposite side showed 29.1° C. And a temperature in the light side of the cloth for gentleman suit lining cloth manufactured in (11) showed 46.1° C., and a temperature in opposite side of the light showed 27.2° C. Accordingly, compared with the experimental control, the cloth for gentleman suit lining cloth manufactured in (11) turned out to block 1.3° C. in the light side (heat source side), and 1.9° C. of heat in the opposite side.

### “Experiment 4”

### (13) Manufacture of Cloth for Coats

A laminated yarn manufactured in (1) was covered by a weft fiber and a core yarn having No. 30 cotton count was manufactured. Next, a weft yarn in which No. 30 count cotton yarn 5 ends might be combined to the above-described core yarn 1 end was woven at a same pitch to a warp yarn warped so that No. 30 count weft yarn might be 150 ends per 1 inch to give 80 ends per 1 inch to obtain a gabardine cloth. The cloth was scoured and dyed in black with disperse dyes to manufacture a cloth for coats.

### (14) Insulation of Heat Examination

A cloth for coats in which a same method as in (13) was repeated and manufactured except that only No. 30 count cotton yarn having been used as weft yarn was used as an experimental control, and insulation of heat examination was conducted by the same method as in (12).

As a result, a temperature in the light side of the experimental control showed 40.5° C., and a temperature in the opposite side to the light showed 28.2° C. Moreover, temperature in the light side of the cloth for gentleman suit lining cloth manufactured in (13) showed 43.3° C., and temperature in the opposite side of the side showed 26° C. Accordingly, compared with the experimental control, the cloth for coats manufactured in (13) turned out to block 2.8° C. in the light side (heat source side), and 2.2° C. of heat in the opposite side.

### “Experiment 5”

### (15) Manufacture of a Shirt

A weft yarn in which No. 40 count cotton yarn 4 ends might be combined to the core yarn used in (13) 1 end was woven to a warp yarn warped so that No. 40 count cotton yarn might be 130 ends per 1 inch to obtain a broadcloth with 85 ends per 1 inch. The cloth was bleached and a shirt was manufactured.

### (16) Insulation of Heat Examination

A same person wore a shirt manufactured in (15) and a shirt of an experimental control, after walk exercising for 5 minutes in 18° C. of atmospheric temperature, and 50% environment of humidity. Stationary state was maintained for 3 minutes in wearing state, and a difference in skin surface temperature was measured with a thermograph. In addition, an experimental control shirt was manufactured in a same method as in (15) except for No. 40 count cotton yarn having been used instead of the core yarn.

Accordingly, as compared with the experimental control, it turned out that the shirt manufactured by (15) was excellent by 3.2° C. in keeping warm property.

### “Experiment 6”

### (17) Manufacture of Cloth for Lace Curtain

Polyester yarn of 150 deniers 90 ends per 1 inch and the twisted yarn (same as the yarn manufactured in (8)) 10 ends inserted equally between the polyester yarns were used as warp yarn to be knitted by a raschel machine that was a kind of warp knitting machine. The fabric was scoured to manufacture a cloth for lace curtain.

### (18) Insulation of Heat Examination

Except for having used a standard white cloth (cotton calico) instead of a brown clothing fabric, a same method as in (12) was repeated and insulation of heat examination was conducted. In addition, a cloth for lace curtain manufactured by a same method as in (17), except having used a yarn of 150 deniers of polyester instead of the twisted yarn, was used as an experimental control.

As a result, a temperature in the light side of the experimental control showed 41.7° C., and a temperature in opposite side of the light showed 25.8° C. And a temperature in the light side of the cloth for lace curtain manufactured in (17) showed 43.8° C., and a temperature in opposite side of the light showed 26.3° C. Accordingly, it turned out that the cloth for lace curtain manufactured in (17) gave 2.1° C. higher in the light side.

Thus, a laminated yarn 1 and a cloth including the laminated yarn 1 are equipped with outstanding aesthetic appreciation property while they are equipped with outstanding antibacterial property, washing resistance, prevention of temperature rising, insulation of heat, antistatic property and the like.

In addition, the present invention is not limited to the above-described embodiments and Examples, and various modification is possible within a range of technical matter indicated in Claims.

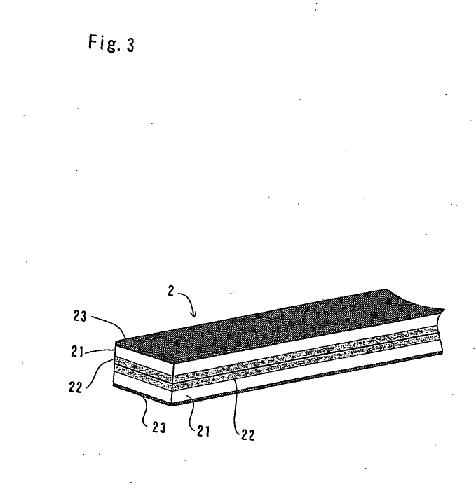

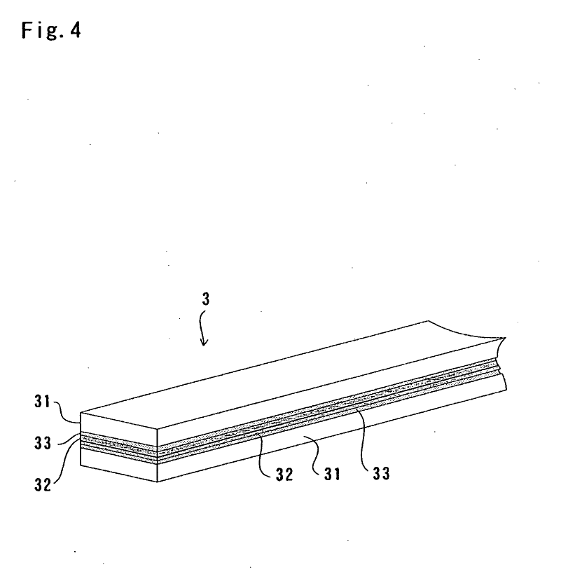

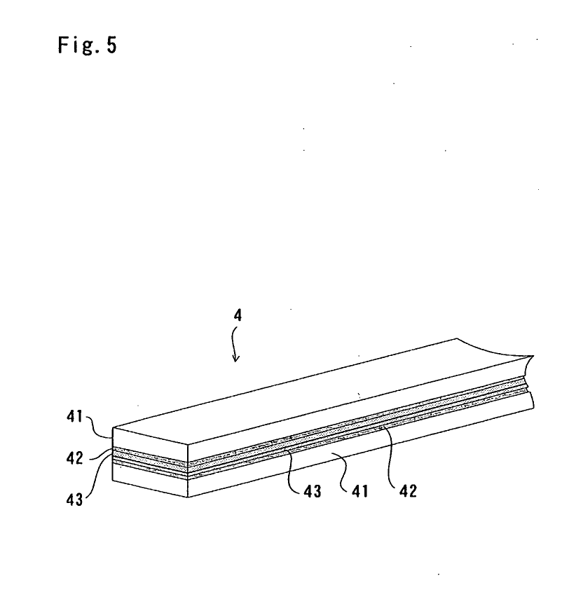

For example, as shown in FIG. 3, a coat layer 23 may be provided outside of a synthetic resin film 21 that constitutes a laminated yarn 2. As a material of coat layer 23, barium oxide, titanium oxide with photo catalytic function, silicon compound and the like may be mentioned, for example.

When barium oxide is used for a coat layer 23, X ray blocking property of a laminated yarn 2 may be increased. For example, a cloth woven by a laminated yarn 2 in which vapor deposition membrane 22 is constituted by silver of thickness of 200 nm, and a coat layer with a thickness of 5 to 200 microns made of barium oxide prepared on a synthetic resin film 21 may be imaged by X-rays. Textiles woven with 20 to 30 of this laminated yarn 2 per 1 inch as warp and weft yarns, respectively, may block electromagnetic wave of about 60 db level.

In the case where titanium oxide is used for coat layer 23, killed microorganism by an antibacterial metal of a vapor deposition membrane 22 may be decomposed and detoxified with a work of active oxygen generated by a photo catalyst (titanium oxide), and in the case where silicon compound is used for coat layer 23, keeping warm property of a laminated yarn 2 may be increased.

Moreover, as shown in FIG. 4, a coat layer 33 made of pigments, such as titanium oxide, may be provided between a vapor deposition membrane 32 and a synthetic resin film 31. Thereby, a metal color of antibacterial metal may be disappeared, and use in textiles such as white robe in which yarns of metal color cannot be used becomes possible.

And as shown in FIG. 5, a coat layer 43 made of barium oxide and the like may be provided on a vapor deposition membrane 42. Thereby, even if the amount of antibacterial metal used constituting the vapor deposition membrane 42 may be reduced, a same level of insulation of electromagnetic waves may be obtained, and production cost may be lowered when an antibacterial metal is a silver.

Furthermore, a laminated yarn may be twisted with wooly nylon and the like to obtain a twisted yarn, or staple fiber made of natural fiber, such as cotton, or synthetic fibers, such as polyester, is twisted around a laminated yarn to obtain a core yarn. Thereby dye affinity and a usage range of the laminated yarn may be extended while being able to improve a touch to skin of the laminated yarn.

In addition, the laminated yarn can also be used as a material of brushes for toilets and the like, or for mops for cleaning besides cloth product by increasing thickness of a synthetic resin film. A cloth with a laminated yarn included therein may be adhered on a concrete wall, ceiling, floor, and the like, or may be applied inside, and may also be used as electromagnetic wave removal materials.

### INDUSTRIAL APPLICABILITY

A laminated yarn of the present invention is a yarn having a sandwiched structure in which both sides of a vapor deposition membrane made of an antibacterial metal are sandwiched with synthetic resin films, thereby it had a beautiful appearance and high antibacterial property, an even after repeated washing antibacterial activity was not deceased, and the yarn showed high prevention of temperature rising, insulation of heat, antistatic property, insulation of electromagnetic wave, and flexibility.

Moreover, decomposition function by a photocatalyst, keeping warm function, and insulation of electromagnetic wave could also be provided by preparing a coat layer outside of a synthetic resin film.

Moreover, by preparing a coat layer made of pigments, such as titanium oxide, between a vapor deposition membrane and a synthetic resin film, metal color of antibacterial metal was decreased and coloring in various color became possible.

Furthermore, by preparing a coat layer on a vapor deposition membrane, an amount of antibacterial metals used, such as silver used as a vapor deposition membrane, could be reduced, and the laminated yarn could also be manufactured more cheaply.

In addition, a dye affinity was increased and a usage range of a laminated yarn was extended while being able to improve a touch to skin of a laminated yarn by twisting cotton staple fiber and the like around a laminated yarn to obtain a core yarn.

1-3. (canceled)

4. A method for providing a laminated yarn with antistatic and antimicrobial properties, comprising:
providing each of a first and second polyester film with a vapor-deposited membrane comprising a layer of silver metal vapor-deposited by ion vacuum deposition, wherein the first and second polyester films each have a thickness varying between 4 and 12 μm and said vapor-deposited membranes have a thickness varying between 50 and 100 nm;
adhering the vapor-deposited membrane of said first polyester film and the vapor-deposited membrane of said second polyester film one to another with a polyester-derived adhesive; and
cutting the resultant structure lengthwise at a width varying between 150 and 226 μm to provide the laminated yarn;
wherein when a knitted fabric comprises said laminated yarn having a polyester film thickness of 12 μm, a silver layer thickness of 50 nm and a yarn width of 226 μm, and which is knitted at intervals of 5 mm, provides the knitted fabric with a triboelectrification charge of 0.19 μC/m² at a triboelectrification voltage of about 50 volts or less measured at 20° C. and 20% relative humidity and with antibacterial properties.

5. The method according to claim 4, wherein said antibacterial properties include a bacilli reduction rate for a Klebsiella pneumoniae bacillus of at least 50% after an exposure of 18 hours at temperature of 35° C.

6. The method according to claim 4, wherein said antibacterial properties include a bacilli reduction rate for a Escherichia coli bacillus of at least 90% after an exposure of 18 hours at temperature of 35° C., after ten washes.

7. The method according to claim 4, wherein:
the intervals are 6 mm; and
said antibacterial properties are a bacilli reduction rate for a Klebsiella pneumoniae bacillus of at least 70% after an exposure of 18 hours at a temperature of 35° C.

8. The method according to claim 4, wherein said antibacterial properties include a bacilli reduction rate for a Trichophyton fungus bacillus of at least 99.9% after an exposure of 18 hours at temperature of 37° C.

9. A method for providing a laminated yarn with antistatic and antimicrobial properties, comprising:
providing each of a first and second polyester film with a vapor-deposited membrane comprising a layer of silver metal vapor-deposited by ion vacuum deposition, wherein the first and second polyester films each have a thickness varying between 4 and 12 μm and said vapor-deposited membranes have a thickness varying between 50 and 100 mm;
forming a silicon compound layer on a surface of each polyester film;
adhering the vapor-deposited membrane of said first polyester film and the vapor-deposited membrane of said second polyester film one to another with a polyester-derived adhesive; and
cutting the resultant structure lengthwise at a width varying between 150 and 226 μm to provide the laminated yarn;
wherein when a knitted fabric comprises said laminated yarn having a polyester film thickness of 12 μm, a silver layer thickness of 50 nm and a yarn width of 226 μm, and which is knitted at intervals of 5 mm, provides the knitted fabric with a triboelectrification charge of 0.19° C./m² at a triboelectrification voltage of about 50 volts or less measured at 20° C. and 20% relative humidity and with antibacterial properties.

10. The method according to claim 9, wherein said antibacterial properties include a bacilli reduction rate for a Klebsiella pneumoniae bacillus of at least 50% after an exposure of 18 hours at a temperature of 35° C.

11. The method according to claim 9, wherein said antibacterial properties include a bacilli reduction rate for an Escherichia coli bacillus of at least 90% after an exposure of 18 hours at a temperature of 35° C., after ten washes.

12. The method according to claim 9, wherein the intervals are 6 mm and wherein said antibacterial properties include a bacilli reduction rate for a Klebsiella pneumoniae bacillus of at least 70% after an exposure of 18 hours at a temperature of 35° C.

13. The method according to claim 9, wherein said antibacterial properties include a bacilli reduction rate for a Trichophyton fungus bacillus of at least 99.9% after an exposure of 18 hours at a temperature of 37° C.
